(19) United States
(12) Patent Application Publication
(10) Pub. No.: US 2014/0138118 A1
(43) Pub. Date: May 22, 2014

(54) NON-HALOGEN MULTILAYER INSULATED WIRE

(71) Applicant: Hitachi Metals, Ltd., Tokyo (JP)

(72) Inventors: Kenichiro Fujimoto, Hitachi (JP); Hitoshi Kimura, Hitachi (JP); Kentaro Segawa, Hitachi (JP)

(73) Assignee: Hitachi Metals, Ltd., Tokyo (JP)

(21) Appl. No.: 14/038,487

(22) Filed: Sep. 26, 2013

(30) Foreign Application Priority Data
Nov. 20, 2012 (JP) 2012-254740

(51) Int. Cl. H01B 3/42; H01B 13/06

(52) U.S. Cl. CPC H01B 3/421; H01B 13/06
USPC 174/120 SR; 427/118

(57) ABSTRACT

A non-halogen multilayer insulated wire includes a conductor, an inner layer covering the conductor, and an outer layer on the inner layer. The inner layer includes a polyolefin resin composition including a high density polyethylene and a copolymer in a mass ratio on the range of 50:50 to 90:10, and the copolymer includes one of an ethylene-ethyl acrylate copolymer including 9% to 35% by mass of ethyl acrylate and an ethylene-vinyl acetate copolymer including 15% to 45% by mass of vinyl acetate. The outer layer is made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, and 0.5 to 5 parts by mass of an inorganic porous filler.

The present application is based on Japanese patent application No. 2012-254740 filed on Nov. 20, 2012, the entire contents of which are incorporated herein by reference.

### BACKGROUND OF THE INVENTION

1. Field of the Invention

The present invention relates to non-halogen multilayer insulated wires that may be superior in abrasion resistance, hydrolysis resistance, flame retardance and heat resistance and exhibit low smoke emission, low toxicity, and high insulation resistance at high temperatures, and particularly to a non-halogen multilayer insulated wire that may comply with European standards (EN standards).

2. Description of the Related Art

Transfer wires and cables used for, for example, railway vehicles and cranes use a halogen-including rubber mixture balanced in terms of oil-fuel resistance, properties at low temperatures, flame retardance, flexibility and cost, such as chloroprene rubber mixture, chlorosulfonyl polyethylene mixture, chlorinated polyethylene mixture, and fluorocarbon rubber mixture.

However, these materials including a large amount of halogen may release a large amount of toxic, harmful gas, depending on burning conditions, when burning. Accordingly, wires and cables having sheaths that are made of halogen-free material (non-halogen material) not including any halogen are increasingly used from the viewpoint of reducing environmental impact and fire safety.

On the other hand, in Europe, where rail vehicle networks are developed, the regional unified standards called EN standards (European standards) are widely adopted. The EN standards require that halogen-free materials used for wires and cables for railway vehicles be resistant to abrasion, hydrolysis and heat, and exhibit flame retardance and low smoke emission because a defective wire or cable may result in a major accident.

Japanese Unexamined Patent Application Publication No. 2011-228189 is intended to satisfy these requirements. This patent document discloses a multilayer insulated wire including a conductor, an inner layer made of a polyester resin composition including a polyester resin (such as polybutylene terephthalate or polybutylene naphthalate), a polyester block copolymer, a hydrolysis inhibitor and a fired clay, and an outer layer made of a polyester resin composition including a polyester resin (such as polybutylene terephthalate or polybutylene naphthalate), a polyester block copolymer, a hydrolysis inhibitor, a fired clay and magnesium hydroxide. The conductor is covered with the inner and outer layers. Each of the polyester block copolymers includes: (a) 20% to 70% by mass of a hard segment mainly including polybutylene terephthalate including 60% by mole or more of terephthalic acid relative to the total number of moles of the dicarboxylic acid component, and (b) 30% to 80% by mass of a soft segment including a polyester including 90% to 99% by mole of an aromatic dicarboxylic acid as the acid component, 1% to 10% by mole of linear aliphatic dicarboxylic acid having a carbon number of 6 to 12, and a linear diol having a carbon number of 6 to 12 as the diol component. The melting point (T) of the polyester block copolymer satisfies the relationship: TO−5>T>TO−60, wherein TO represents the melting point of the polymer including the components of the hard segment.

The EN standards require that the wires and cables be less toxic and exhibit high insulation resistance at high temperatures, in addition to the above characteristics. However, known techniques, including the above cited Japanese Unexamined Patent Application Publication No. 2011-228189, have not been able to produce a wire or cable satisfying all the specifications of the EN standards.

### SUMMARY OF THE INVENTION

In view of the foregoing and other exemplary problems, drawbacks, and disadvantages of the conventional methods and structures, exemplary feature of the present invention is to provide non-halogen multilayer insulated wire. Accordingly, it is an object of the invention to provide non-halogen multilayer insulated wires that may be superior in abrasion resistance, hydrolysis resistance, flame retardance and heat resistance and exhibit low smoke emission, low toxicity, and high insulation resistance at high temperatures, and particularly to provide a non-halogen multilayer insulated wire that may comply with European standards (EN standards).

According to one exemplary aspect of the present invention, a non-halogen multilayer insulated wire is provided.

The non-halogen multilayer insulated wire includes a conductor, an inner layer covering the conductor, and an outer layer disposed over the external surface of the inner layer. The inner layer covering the conductor, the inner layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate.

The outer layer on the external surface of the inner layer, the outer layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

In the above exemplary invention, many exemplary modifications and changes can be made as below (the following exemplary modifications and changes can be made).

The polyolefin resin composite may include the high density polyethylene and the ethylene-ethyl acrylate copolymer in a mass ratio in the range of 50:50 to 90:10.

The polyester resin of the base polymer may be one of polybutylene naphthalate and polybutylene terephthalate.

The hydrolysis inhibitor may be an additive having a carbodiimide skeleton.

The inorganic porous filler may be a fired clay.

The above exemplary modifications may be alone or in any combination thereof.

According to another exemplary aspect of the invention, a method of manufacturing a non-halogen multilayer insulated wire, the method comprising; forming an inner layer covering the conductor, the inner layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate; and forming an outer layer on the external surface of the inner layer, the outer layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

According to another exemplary aspect of the invention, a non-halogen multilayer insulation comprising: a first layer covering the conductor, the first layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate; and an second layer on the external surface of the inner layer, the second layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

Embodiments of the present invention can provide non-halogen multilayer insulated wires that are superior in abrasion resistance, hydrolysis resistance, flame retardance and heat resistance and exhibit low smoke emission, low toxicity, and high insulation resistance at high temperatures, and particularly may provide a non-halogen multilayer insulated wire complying with European standards (EN standards).

### BRIEF DESCRIPTION OF THE DRAWINGS

The foregoing and other exemplary purposes, aspects and advantages will be better understood from the following detailed description of the invention with reference to the drawings, in which:

FIG. 1 is a sectional view of a non-halogen multilayer insulated wire according to an embodiment of the present invention.

FIG. 2A is a sectional view illustrating a method for examining the abrasion resistance of the wires of the Examples, and FIG. 2B is a front view of the method.

FIG. 3 is a representation illustrating a method for examining the flame retardance of the wires of the Examples.

### DESCRIPTION OF THE EXEMPLARY EMBODIMENTS

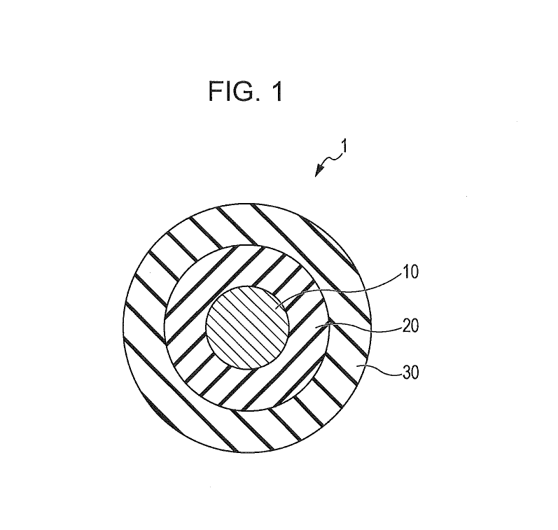

Referring now to the drawings, and more particularly to FIGS. 1-3, there are shown exemplary embodiments of the methods, and structures according to the present invention.

Although the invention has been described with respect to specific exemplary embodiments for complete and clear disclosure, the appended claims are not to be thus limited but are to be construed as embodying all modifications and alternative constructions that may occur to one skilled in the art which fairly fall within the basic teaching herein set forth.

Further, it is noted that Applicant's intent is to encompass equivalents of all claim elements, even if amended later during prosecution.

### Structure of Non-Halogen Multilayer Insulated Wire

FIG. 1 is a sectional view of a non-halogen multilayer insulated wire according to an embodiment of the present invention.

As shown in FIG. 1, the non-halogen multilayer insulated wire 1 includes a conductor 10, an inner layer 20 covering the conductor 10, and an outer layer 30 disposed over the external surface of the inner layer 20. The inner layer 20 includes an polyolefin resin composition including a high density polyethylene and either an ethylene-ethyl acrylate copolymer including 9% to 35% by mass of ethylene acrylate (EA) or an ethylene-vinyl acetate copolymer including 15% to 45% by mass of vinyl acetate (VA), in a mass ratio in the range of 50:50 to 90:10. The outer layer 30 includes a polyester resin composition that includes a base polymer mainly including a polyester resin, and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

The conductor 10 can be selected from conductors generally used in insulated wires.

The inner layer 20 will be described below. In the polyolefin resin composition for the inner layer 20, a high density polyethylene and either an ethylene-ethyl acrylate copolymer (EEA) including 9% to 35% by mass of ethyl acrylate or an ethylene-vinyl acetate copolymer (EVA) including 15% to 45% by mass of vinyl acetate, are included in a mass ratio in the range of 50:50 to 90:10.

The total content of the high density polyethylene and the ethylene-ethyl acrylate copolymer or ethylene-vinyl acetate copolymer in the polyolefin resin composition is preferably 65% by mass or more, more preferably 75% by mass, still more preferably 85% by mass, and most preferably 95% by mass.

The high density polyethylene is intended to enhance mechanical strength. If the mass ratio of the high density polyethylene content to the ethylene-ethyl acrylate copolymer or the ethylene-vinyl acetate copolymer is less than 50%, that is, if the percentage of the high density polyethylene is less than 50% in the total mass of the high density polyethylene and the ethylene-ethyl acrylate copolymer or the ethylene-vinyl acetate copolymer, then abrasion resistance is insufficient. In contrast, if the percentage of the high density polyethylene is more than 90%, then flame retardance is insufficient. The high density polyethylene has a density of preferably, but not limited to, 0.942 g/cm³ or more.

The ethylene-ethyl acrylate copolymer or the ethylene-vinyl acetate copolymer is used for forming a carbonized layer when the wire is burned. The ethyl acrylate (EA) content in the ethylene-ethyl acrylate copolymer may be in a range from 9% to 35% by mass. If the EA content is less than 9% by mass, then flame retardance is reduced, and if it is more than 35% by mass, then mechanical properties are markedly degraded. The vinyl acetate (VA) content in the ethylene-vinyl acetate copolymer may be in a range from 15% to 45% by mass. If the VA content is less than 15% by mass, then flame retardance is reduced, and if it is more than 45% by mass, then mechanical properties are markedly degraded.

The mass ratio of the ethylene-ethyl acrylate copolymer or ethylene-vinyl acetate copolymer content to the high density polyethylene may be limited to 10% to 50%. That is, the percentage of the ethylene-ethyl acrylate copolymer or ethylene-vinyl acrylate copolymer may be limited to 10% to 50% in the total mass of the high density polyethylene and the ethylene-ethyl acrylate copolymer or ethylene-vinyl acetate copolymer. If it is less than 10%, then flame retardance is insufficient. In contrast, if it is more than 50%, then the high density polyethylene content is reduced and abrasion resistance is insufficient.

The polyolefin resin composite for the inner layer 20 may further include any other polyolefin resin within the range in which the flame retardance or abrasion resistance is degraded. Such polyolefin resins include low density polyethylene, medium density polyethylene, low density linear polyethylene, ultra-low density linear polyethylene, ethylene-methyl methacrylate copolymer, ethylene-methyl acrylate copolymer, ethylene-styrene copolymer, ethylene-maleic anhydride copolymer, and maleic-anhydride grafted low density linear polyethylene. These polyolefin resins may be modified with maleic acid or its derivative. The polyolefin resins may be used singly or in combination.

The outer layer 30 will now be described. The polyester resin composition used in the outer layer 30 includes a base polymer mainly including a polyester resin, and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

The phrase “base polymer mainly including a polyester resin” may be understood to mean that the content of the polyester resin is the largest in the base polymer. More specifically, the polyester resin content in the base polymer may be greater than or equal to 50% by mass. Preferably, the polyester resin content may be 70% by mass or more, more preferably 80% by mass or more, and still more preferably 90% by mass or more. Polyester resin is superior in heat resistance and abrasion resistance, and is accordingly used in the present embodiment.

Examples of the polyester resin include polybutylene naphthalate resin (PBN), polybutylene terephthalate resin (PBT), polytrimethylene terephthalate resin, polyethylene naphthalate resin, and polyethylene terephthalate resin. These polyester resins can be used in combination to the extent that the advantages of the invention are not lost. Polybutylene naphthalate resin and polybutylene terephthalate resin will be described in detail by way of example.

The polybutylene naphthalate resin used in the present embodiment is a polyester including an acid component mainly including naphthalene dicarboxylic acid, exemplarily naphthalene-2,6-dicarboxylic acid, and a glycol component mainly including 1,4-butanediol. In other words, all or most (generally 90% by mole or more, preferably 95% by mole or more) of the repeating unit of the polybutylene naphthalate is butylene naphthalene dicarboxylate.

The polybutylene naphthalate resin may be copolymerized with the following components as long as its physical properties are not degraded.

Acid components other than naphthalene dicarboxylic acid may be copolymerized, including aromatic dicarboxylic acids such as phthalic acid, isophthalic acid, terephthalic acid, diphenyldicarboxylic acid, diphenyletherdicarboxylic acid, diphenoxyethanedicarboxylic acid, diphenylmethanedicarboxylic acid, diphenylketonedicarboxylic acid, diphenylsulfidedicarboxylic acid, and diphenylsulfonedicarboxylic acid; aliphatic dicarboxylic acids, such as succinic acid, adipic acid, and sebacic acid; and alicyclic dicarboxylic acids, such as cyclohexanedicarboxylic acid, tetralindicarboxylic acid, and decalindicarboxylic acid.

A glycol component may be copolymerized, such as ethylene glycol, propylene glycol, trimethylene glycol, pentamethylene glycol, hexamethylene glycol, octamethylene glycol, neopentyl glycol, cyclohexanedimethanol, xylylene glycol, diethylene glycol, polyethylene glycol, bisphenol A, catechol, resorcinol, hydroquinone, dihydroxydiphenyl, dihydroxydiphenyl ether, hydroquinone, dihydroxydiphenyl, dihydroxydiphenyl ether, dihydroxydiphenylmethane, dihydroxydiphenyl ketone, dihydroxydiphenylsulfide, and dihydroxydiphenyl sulfone.

An oxycarboxylic acid component may be copolymerized, such as oxybenzoic acid, hydroxynaphthoic acid, hydroxydiphenylcarboxylic acid, and ω-hydroxycaproic acid.

The polyester may be copolymerized with trifunctional or more highly functional compounds such as glycerol, trimethylpropane, pentaerythritol, trimellitic acid, and pyromellitic acid, as long as the polyester substantially maintain its moldability.

In the present embodiment, the terminal carboxyl group content of the polybutylene naphthalate resin is not particularly limited, but is exemplary low.

The polybutylene naphthalate resin is prepared by polycondensation of a naphthalenedicarboxylic acid and/or its functional derivative and butylene glycol and/or its functional derivative, in a known aromatic polyester synthesis.

The polybutylene terephthalate resin used in the present embodiment is a polyester having a butylene terephthalate repeating unit as the main component. The butylene terephthalate repeating unit is formed of 1,4-butanediol as a polyhydric alcohol component and terephthalic acid or its ester-forming derivative as a polyvalent carboxylic acid component. The repeating unit “as the main component” may be understood to mean that the butylene terephthalate unit accounts for 70% by mole or more of all the polyvalent carboxylic acid-polyhydric alcohol units. Preferably, the butylene terephthalate unit accounts for 80% by mole or more, more preferably 90% by mole or more, and still more preferably 95% by mole or more.

Polyvalent carboxylic acid components other than terephthalic acid, used for the polybutylene terephthalate resin include aromatic polyvalent carboxylic acids, such as 2,6-naphthalenedicarboxylic acid, 2,7-naphthalenedicarboxylic acid, isophthalic acid, phthalic acid, trimesic acid, and trimellitic acid; aliphatic dicarboxylic acids, such as oxalic acid, malonic acid, succinic acid, glutaric acid, adipic acid, suberic acid, azelaic acid, sebacic acid, and decanedicarboxylic acid; alicyclic dicarboxylic acids, such as cyclohexanedicarboxylic acid; and ester-forming derivatives of these polyvalent carboxylic acids (for example, lower alkyl esters of polyvalent carboxylic acids, such as dimethyl terephthalate). These polyvalent carboxylic acid components other than terephthalic acid may be used singly or in combination.

Polyhydric alcohol components other than 1,4-butanediol, used in the polybutylene terephthalate resin include aliphatic polyhydric alcohols, such as ethylene glycol, diethylene glycol, propylene glycol, neopentyl glycol, pentanediol, hexanediol, glycerol, trimethylolpropane, and pentaerythritol; alicyclic polyhydric alcohols, such as 1,4-cyclohexanedimethanol; aromatic polyhydric alcohols, such as bisphenol A and bisphenol Z; and polyalkylene glycol, such as polyethylene glycol, polypropylene glycol, polytetramethylene glycol, and polytetramethyleneoxide glycol. These polyhydric alcohol components other than 1,4-butanediol may be used singly or in combination.

In view of hydrolysis resistance, the terminal carboxyl group content in the polybutylene terephthalate resin is preferably 50 equivalents per ton (hereinafter represented by eq/t) or less, more preferably 40 eq/t or less, and still more preferably 30 eq/t or less. A polybutylene terephthalate resin including more than 50 eq/t of terminal carboxyl group is unsuitable in view of hydrolysis resistance.

The polybutylene terephthalate resin may be composed of a single polybutylene terephthalate, or may be a mixture of different polybutylene terephthalates varying in terminal carboxyl group content, melting point, amount of catalyst required, or any other factor.

The polyester resin composition used in the outer layer 30 includes a polyester block copolymer. The polyester block copolymer is added to enhance the heat resistance and to impart flexibility.

To 100 parts by mass of the base polymer, 50 to 150 parts by mass of a polyester block copolymer may be added. If the amount of polyester block copolymer is less than 50 parts by mass, then the resulting outer layer does not exhibit desired flexibility. In contrast, if the amount exceeds 150 parts by mass, then the toxicity is not sufficiently low and the abrasion resistance is insufficient.

The polyester block copolymer may include a hard segment including 60% by mole or more (preferably 70% by mole or more) of polybutylene terephthalate. The hard segment may have been copolymerized with an aromatic dicarboxylic acid, other than terephthalic acid, having a benzene or naphthalene ring, an aliphatic dicarboxylic acid having a carbon number of 4 to 12, an aliphatic diol, other than tetramethylene glycol, having a carbon number of 2 to 12, or an alicyclic diol such as cyclohexanedimethanol, in a proportion of less than 30% by mole, preferably less than 10% by mole, relative to the total amount of the dicarboxylic acids. It is exemplary that the content of such polymerization component be low because a lower content results in a higher melting point. However, copolymerization of the hard segment is performed to enhance the flexibility. Unfortunately, if the content of copolymerization component is increased, the compatibility of the polyester block copolymer with polybutylene naphthalate is reduced and may result in degraded abrasion resistance.

The polyester block copolymer also includes a soft segment that is a polyester including 90% to 99% by mole of an aromatic dicarboxylic acid, and 1% to 10% by mole of linear aliphatic dicarboxylic acid having a carbon number of 6 to 12, and having a diol component which is a linear diol having a carbon number of 6 to 12. Examples of the aromatic dicarboxylic acid include terephthalic acid and isophthalic acid. Examples of the linear aliphatic dicarboxylic acid having a carbon number of 6 to 12 include adipic acid and sebacic acid. The linear aliphatic dicarboxylic acid content is preferably 1% to 10% by mole, more preferably 2% to 5% by mole, relative to the total acid component of the polyester in the soft segment. If the linear aliphatic dicarboxylic acid content is 10% by mole or more, the compatibility of the polyester block copolymer with polybutylene naphthalate is degraded. In contrast, if it is 1% by mole or less, the flexibility of the soft segment is degraded and, consequently, the softness of the polyester resin composition is degraded. The polyester constituting the soft segment must be amorphous or have low crystallinity. Accordingly, isophthalic acid is preferably used in a proportion of 20% by mole or more to the total acid component of the soft segment. As with the hard segment, the soft segment may be copolymerized with a small amount of other components. However, this copolymerization leads to degraded compatibility with polybutylene naphthalate. Accordingly, the amount of copolymerization component may be preferably 10% by mole or less, and more preferably 5% by mole or less.

In the polyester block copolymer used in the present embodiment, the mass ratio of the hard segment to the soft segment is preferably in the range of 20:80 to 50:50, and more preferably in the range of 25:75 to 40:60. If the proportion of the hard segment is greater than the above ranges, then the resulting material is likely to be too hard to use. If the proportion of the soft segment is less than the above ranges, then the resulting material is degraded in crystallinity and is likely to be difficult to handle.

The lengths of the soft and hard segments of the polyester block copolymer are preferably, but are not limited to, about 500 to 7000, more preferably about 800 to 5000, in terms of molecular weight. Although the lengths of these segments cannot be directly measured, they may be estimated using the Flory equation using the compositions of the polyesters defined by the soft segment or the hard segment, the melting point of the polyester of the hard segment, and the melting point of the resulting polyester block copolymer.

The melting point (T) of the polyester block copolymer is preferably in the range of “TO−5>T>TO−60”, wherein TO represents the melting point of a polymer defined by the hard segment component. More specifically, the melting point (T) is preferably between TO−5 and TO−60, more preferably between TO−10 and TO−50, and still more preferably between TO−15 and TO−40.

The melting point (T) may be greater than the melting point of a comparable random copolymer by 10° C. or more, preferably 20° C. or more. If the melting point of the random copolymer is not determined, then the melting point (T) may be set to 150° C. or more, preferably 160° C. or more.

Comparable polyester random copolymers, which are generally amorphous and in a starch syrup state and have low glass transition temperature, are difficult to handle in practice because of their inferior moldability or sticky surface, even if they are used instead of the polyester block copolymer.

The intrinsic viscosity of the polyester block copolymer measured at 35° C. in o-chlorophenol is preferably 0.6 or more, and more preferably 0.8 to 1.5. A polyester block copolymer having an intrinsic viscosity lower than the above range disadvantageously exhibits a low strength.

In a synthesis process of the polyester block copolymer, for example, polymers defining the soft segment and the hard segment are prepared separately, and these polyesters are melt-blended so that the polyester block copolymer has a lower melting point than the polyester defining the hard segment. Since the melting point of the polyester block copolymer varies with mixing temperature and mixing time, it is exemplary that a deactivator of the catalyst, such as phosphorus oxyacid, be added to deactivate the catalyst, when entering a state where the reaction system exhibits a desired melting point.

The polyester resin composition used in the outer layer 30 may further include a hydrolysis inhibitor. Examples of the hydrolysis inhibitor include, but are not limited to, compounds having carbodiimide skeletons, such as dicyclohexylcarbodiimide, diisopropylcarbodiimide, and 1-ethyl-3-(3-dimethylaminopropyl)carbodiimide hydrochloric acid salt.

The hydrolysis inhibitor content may be 0.5 to 5 parts by mass, preferably 1 to 4 parts by mass, more preferably 2 to 4 parts by mass, still more preferably 2 to 3 parts by mass, relative to 100 parts by mass of the base polymer. With a content of less than 0.5 part by mass, the hydrolysis inhibitor cannot function sufficiently to inhibit hydrolysis. In contrast, a hydrolysis inhibitor having a content of more than 5 parts by mass cannot achieve low toxicity.

The polyester resin composition used in the outer layer 30 may further include an inorganic porous filler. The inorganic porous filler may be added to enhance the electrical properties of the outer layer 30.

The inorganic porous filler content may be 0.5 to 5 parts by mass, preferably 0.5 to 3 parts by mass, more preferably 0.5 to 2 parts by mass, still more preferably 0.5 to 1 part by mass, relative to 100 parts by mass of the base polymer. Since an excessively small amount of inorganic porous filler cannot sufficiently trap ions and results in reduced insulation resistance or degraded electrical properties. In contrast, an excessively large amount of inorganic porous filler undesirably leads to degraded abrasion resistance.

The inorganic porous filler used in the present embodiment may preferably include a specific surface area of 5 m²/g or more.

The inorganic porous filler is exemplary, but not limited to, fired clay, and may be zeolite, Mesalite, anthracite, foamed perlite or active carbon. The inorganic porous filler may be surface-treated with, for example, silane or fatty acid.

The polyester resin composition used in the outer layer 30 may further include magnesium hydroxide. Magnesium hydroxide is added to enhance flame retardance and impart a property of low smoke emission.

To 100 parts by mass of the base polymer, 10 to 30 parts by mass of magnesium hydroxide is added. A magnesium hydroxide content of less than 10 parts by mass cannot sufficiently achieve flame retardance and low smoke emission. In contrast, a polyester resin composition having a magnesium hydroxide content of more than 30 parts by mass results in a wire having reduced flexibility and reduced abrasion resistance.

The magnesium hydroxide may be surface-treated with, for example, a fatty acid, a metal salt of a fatty acid, vinyltrimethoxysilane, vinyltriethoxysilane, methacryloxypropyltrimethoxysilane, methacryloxypropyltriethoxysilane, aminopropyltrimethoxysilane or aminopropyltriethoxysilane. Untreated magnesium hydroxide may be used.

These materials may each be added to the polyester resin of the base polymer by a known process in an arbitrary stage before the polyester resin composition is applied. Most simply, materials such as the polyester resin, the polyester block copolymer, the hydrolysis inhibitor, the inorganic porous filler and magnesium hydroxide may be melt-blended and then formed into pellets by extrusion.

The resin compositions for the inner layer 20 and the outer layer 30 may each include known additives such as a pigment, a dye, filler, a core agent, a release agent, an antioxidant, a stabilizer, an antistatic agent and a lubricant, within ranges in which advantageous effects of the present invention can be produced.

In the manufacture of the multilayer insulated wire 1 of the present embodiment, the resin compositions for the inner layer 20 and the outer layer 30 may be applied separately or simultaneously by extrusion. The multilayer insulated wire 1 coated with the inner layer 20 and the outer layer 30 may be subjected to irradiation cross-linking, if necessary.

The insulation of the insulated wire 1, defined by the two layers (inner layer 20 and outer layer 30) may preferably have a thickness of 0.15 to 0.5 mm. Preferably, the thickness of the inner layer 20 is 0.05 to 0.2 mm, and the thickness of the outer layer 30 is 0.1 to 0.3 mm.

The insulation of the multilayer insulated wire 1 is not limited to a double-layer structure, as long as including the inner layer 20 and the outer layer 30. For example, an insulating layer may be provided between the conductor 10 and the inner layer 20, or an intermediate layer may be provided between the inner layer 20 and the outer layer 30, as long as advantageous effects of the present invention can be produced.

The present invention will be further described in detail with reference to Examples. The invention is however not limited to the examples.

### Examples

Multilayer insulated wire samples of Examples 1 to 5 and Comparative Examples 1 to 9 and a multilayer insulated wire according to the known art were prepared as below. Compositions of the resin compositions of the inner and outer layers of the multilayer insulated wire samples are shown in Table 1, and the evaluation results are shown in Table 2.

### Materials Used

HDPE (high density polyethylene): HI-ZEX (registered trademark) 550P, produced by Prime Polymer Co., Ltd.

EEA (ethylene-ethyl acrylate copolymer): REXPEARL (registered trademark) EEA A 1150 (ethyl acrylate content: 15% by mass), produced by Japan Polyethylene Corporation.

PBN (polybutylene naphthalate resin): TQB-OT, produced by Teijin Limited

PBT (polybutylene terephthalate resin): NOVADURAN (registered trademark) 5026, produced by Mitsubishi Engineering-Plastics Corporation

PEBC (polyester block copolymer): Nouvelan (registered trademark) TRB-EL 2, produced by Teijin Limited

Hydrolysis inhibitor (polycarbodiimide): CARBODILITE (registered trademark) HMV-8CA, produced by Nisshinbo Chemical Inc.

Fired clay 1 (surface-treated fired kaolin): TRANSLINK 77, produced by BASF

Fired clay 2 (surface-treated fired kaolin): SATINTONE (registered trademark) SP-33, produced by Engelhard Corporation

Magnesium hydroxide: Kisuma (registered trademark) 5L, produced by Kyowa Chemical Industry Co., Ltd.

TABLE 1

| | Constituent (parts by mass except for HDPE and EEA, mass ratio for HDPE and EEA) | | | | | | | | | | | |
|---|---|---|---|---|---|---|---|---|---|---|---|---|
| | Inner layer polyolefin resin composition A | | | | | | Outer layer polyester resin composition B | | | | | |
| | | | | | Fired | Hydrolysis | | | | Hydrolysis | Fired | Magnesium |
| | HDPE | EEA | PBN | PEBC | clay 1 | inhibitor | PBN | PBT | PEBC | inhibitor | clay 2 | hydroxide |
| Example 1 | 50 | 50 | — | — | — | — | 100 | — | 66.7 | 3 | 0.5 | 20 |
| Example 2 | 70 | 30 | — | — | — | — | 100 | — | 66.7 | 2 | 1 | 10 |
| Example 3 | 90 | 10 | — | — | — | — | 100 | — | 66.7 | 3 | 1 | 20 |
| Example 4 | 70 | 30 | — | — | — | — | 100 | — | 66.7 | 3 | 1 | 30 |
| Example 5 | 70 | 30 | — | — | — | — | — | 100 | 66.7 | 3 | 1 | 20 |
| Comparative | 100 | — | — | — | — | — | 100 | — | 66.7 | 1 | 1 | 20 |
| Example 1 | | | | | | | | | | | | |
| Comparative | 30 | 70 | — | — | — | — | 100 | — | 66.7 | 5 | 1 | 20 |
| Example 2 | | | | | | | | | | | | |
| Comparative | — | 100 | — | — | — | — | 100 | — | 66.7 | 3 | 2 | 20 |
| Example 3 | | | | | | | | | | | | |
| Comparative | 70 | 30 | — | — | — | — | 100 | — | 66.7 | 3 | 1 | 40 |
| Example 4 | | | | | | | | | | | | |
| Comparative | 70 | 30 | — | — | — | — | 100 | — | 66.7 | 3 | 1 | 5 |
| Example 5 | | | | | | | | | | | | |
| Comparative | 70 | 30 | — | — | — | — | 100 | — | 180 | 3 | 1 | 20 |
| Example 6 | | | | | | | | | | | | |
| Comparative | 70 | 30 | — | — | — | — | 100 | — | 20 | 3 | 1 | 20 |
| Example 7 | | | | | | | | | | | | |
| Comparative | 70 | 30 | — | — | — | — | 100 | — | 66.7 | 3 | 10 | 20 |
| Example 8 | | | | | | | | | | | | |
| Comparative | 70 | 30 | — | — | — | — | 100 | — | 66.7 | 10 | 1 | 20 |
| Example 9 | | | | | | | | | | | | |
| Known art 1 | — | — | 100 | 82 | 1 | 3 | 100 | — | 66.7 | 1 | 1 | 20 |

### Preparation of Multilayer Insulated Wire

The resulting resin compositions A and B were dried in a hot air thermostatic chamber respectively at 80° C. for 8 hours or more and at 120° C. for 8 hours or more. Resin composition A was extruded directly onto a tin-plated annealed copper wire of 1.2 mm in diameter to form a coating of 0.15 mm in thickness, and then resin composition B was further extruded to a thickness of 0.10 mm on the periphery of the coating of resin composition A. Thus, multilayer insulated wire samples of Examples, Comparative Examples and known art were prepared. For the extrusion, dice having diameters of 4.2 mm and 2.0 mm and a nipple were used, and the resin compositions were extruded through a cylinder at a temperature of 220 to 270° C. and a head at a temperature of 265° C. The take-up rate was 10 m/min.

The multilayer insulated wires were evaluated as below for abrasion resistance, hydrolysis resistance, flame retardance, heat resistance, smoke emission, toxicity, and insulation resistance at a high temperature.

### Abrasion Resistance Test

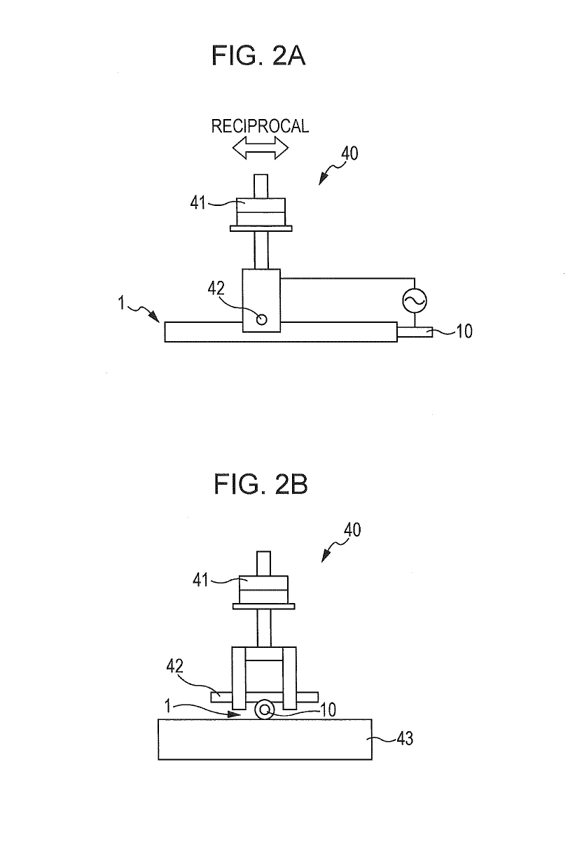

As shown in FIGS. 2A and 2B, the prepared multilayer insulated wire 1 placed on a testing table 43 was reciprocally moved with a load of 9 N applied with an abrasion indenter 42 of an abrasion tester 40, and the number of times of reciprocal movement was counted until short circuit occurred in the wire 1. The load was controlled with weights 41. When the number of times of reciprocal movement was 150 or more, the test sample was determined to be good. When it was less than 150, the sample was determined to be bad.

### Hydrolysis Resistance Test

The multilayer insulated wire 1 from which the conductor 10 had been removed was allowed to stand in a 85° C./85% RH constant temperature and humidity chamber for 30 days. Then, the sample was wound around itself. Samples that exhibited no breakage were determined to be good, and samples that exhibited breakage were determined to be bad.

### Flame Retardance Test

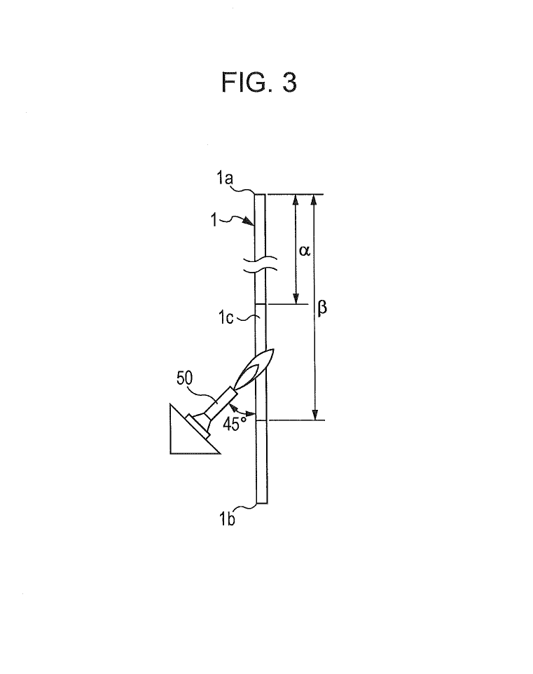

The prepared multilayer insulated wire 1 was subjected to flame retardance test in accordance with IEC flame test (IEC 60332-1). As shown in FIG. 3, the multilayer insulated wire 1 was held in a vertical position at the upper held portion 1a and the lower held portion 1b, and a flame was applied at an angle of 45° with a burner 50 to the wire 1 at a position 475±5 mm from the upper held portion 1a for a predetermined time. Then, the burner 50 was removed to extinguish the flame, and the carbonized portion is was examined. When the length α from the upper held portion 1a to the upper end of the carbonized portion 1c was 50 mm or more and the length β from the upper held portion 1a to the lower end of the carbonized portion 1c was 540 mm or less, the sample was determined to be good. When length α and/or length β was outside these ranges, the sample was determined to be bad.

### Heat Resistance Test

For evaluating the heat resistance, properties of samples that had been subjected to the following heat aging test were examined by a tensile test. For the heat aging test, the multilayer insulated wire 1 from which the conductor 10 had been removed was subjected to heat treatment in a thermostatic chamber under of 150° C. for 96 hours in accordance with JIS C3005, and was then allowed to stand at room temperature for about 12 hours. For examining properties after the heat aging test, the heat-treated sample was subjected to tensile test at a tension rate of 200 mm/min in accordance with JIS C3005. Samples exhibiting an elongation rate (elongation before heat aging test/elongation after the heat aging test×100) of 70% or more were determined to be good, and samples exhibiting an elongation rate of less than 70% were determined to be bad.

### Smoke Emission Density Test

The samples of the multilayer insulated wire 1 were burned, and the transmittance of the smoke generated by the burning was measured, in accordance with EN 50268 2. Samples exhibiting a transmittance of 70% or more were determined to be good, and samples exhibiting a transmittance of less than 70% were determined to be bad.

### Toxicity Test

In accordance with EN 50305 9.2, the conductor 10 was removed from the multilayer insulated wire 1, and the rest of the wire 1, or the inner layer 20 and the outer layer 30, was cut in round slices. One gram of the slices was burned at 800° C. Five gases (CO, CO₂, HCN, SO₂, NOₓ) generated by the burning were subjected to quantitative analysis, and the toxicity index (ITC value) of the wire 1 was calculated from the results of the quantitative analysis with predetermined weighting. Samples having ITC values of 6 or less were determined to be good, and samples having TIC values of more than 6 were determined to be bad.

### Measurement of Insulation Resistance at High Temperature

In accordance with EN 50305 6.4, 5 m samples of the multilayer insulated wire 1 were immersed in hot water of 90° C. for one hour, and then, the insulation resistance was measured at voltages varying from 80 V to 500 V. Measured values were converted into insulation resistances per kilometer for evaluation. When the insulation resistance was 600 MΩ/km or more, the sample was determined to be good. When it was less than 600 MΩ/km, the sample was determined to be bad.

### Comprehensive Evaluation

Samples that were determined to be good in all the tests of abrasion resistance, hydrolysis resistance, flame retardance, heat resistance, smoke emission, toxicity and high-temperature insulation resistance passed the comprehensive evaluation, and samples that were determined to be bad in any one of the tests failed the comprehensive evaluation.

TABLE 2

| | | | | | | | Insulation | |
|---|---|---|---|---|---|---|---|---|
| | | | | | | | resistance at | |
| | Abrasion | Hydrolysis | Flame | Heat | Smoke | | high | Comprehensive |
| | resistance | resistance | retardance | resistance | emission | Toxicity | temperature | evaluation |
| Example 1 | Good | Good | Good | Good | Good | Good | Good | Passed |
| Example 2 | Good | Good | Good | Good | Good | Good | Good | Passed |
| Example 3 | Good | Good | Good | Good | Good | Good | Good | Passed |
| Example 4 | Good | Good | Good | Good | Good | Good | Good | Passed |
| Example 5 | Good | Good | Good | Good | Good | Good | Good | Passed |
| Comparative | Good | Good | Bad | Good | Good | Good | Good | Failed |
| Example 1 | | | | | | | | |
| Comparative | Bad | Good | Good | Good | Good | Good | Good | Failed |
| Example 2 | | | | | | | | |
| Comparative | Bad | Good | Good | Good | Good | Good | Good | Failed |
| Example 3 | | | | | | | | |
| Comparative | Bad | Bad | Good | Bad | Good | Good | Good | Failed |
| Example 4 | | | | | | | | |
| Comparative | Good | Good | Bad | Good | Bad | Bad | Good | Failed |
| Example 5 | | | | | | | | |
| Comparative | Bad | Good | Good | Good | Good | Good | Good | Failed |
| Example 6 | | | | | | | | |
| Comparative | Good | Good | Good | Bad | Good | Good | Good | Failed |
| Example 7 | | | | | | | | |
| Comparative | Bad | Good | Good | Bad | Good | Good | Good | Failed |
| Example 8 | | | | | | | | |
| Comparative | Good | Good | Good | Good | Good | Bad | Good | Failed |
| Example 9 | | | | | | | | |
| Known art 1 | Good | Good | Good | Good | Good | Bad | Bad | Failed |

Table 2 shows that the samples of Examples 1 to 5, which are within the scope of the present invention, were superior in abrasion resistance, hydrolysis resistance, flame retardance and heat resistance, and exhibited low smoke emission, low toxicity, and high insulation resistance at a high temperature.

On the other hand, the sample of Comparative Example 1, whose inner layer was made of only HDPE, failed in flame retardance. The sample of Comparative Example 2, in which the HDPE content was less than the range specified in an embodiment of the invention, failed in abrasion resistance. The sample of Comparative Example 3, having an inner layer that included only EEA, failed in abrasion resistance. The sample of Comparative Example 4, in which the magnesium hydroxide content was higher than the range specified in an embodiment of the invention, failed in abrasion resistance, hydrolysis resistance and heat resistance (elongation after heat treatment). The sample of Comparative Example 5, in which the magnesium hydroxide content was low, failed in flame retardance, smoke emission and toxicity. The sample of Comparative Example 6, in which the polyester block copolymer content in the outer layer material was high, failed in abrasion resistance. The sample of Comparative Example 7, in which the polyester block copolymer content was low, failed in heat resistance (elongation after heat treatment). The sample of Comparative Example 8, in which the fired clay content in the outer layer material was high, failed in abrasion resistance and heat resistance (elongation after heat treatment). The sample of Comparative Example 9, in which the hydrolysis inhibitor content in the outer layer material was high, failed in toxicity.

Also, the sample of the known art, in which the base polymers of the inner and outer layers were each polybutylene naphthalate (PEN), failed in toxicity and insulation resistance at a high temperature.

What is claimed is:

1. A non-halogen multilayer insulated wire comprising:
a conductor;
an inner layer covering the conductor, the inner layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate; and
an outer layer on the external surface of the inner layer, the outer layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

2. The non-halogen multilayer insulated wire according to claim 1, wherein the polyolefin resin composition includes the high density polyethylene and the ethylene-ethyl acrylate copolymer in a mass ratio in the range of 50:50 to 90:10.

3. The non-halogen multilayer insulated wire according to claim 1, wherein the polyester resin of the base polymer comprises one of polybutylene naphthalate and polybutylene terephthalate.

4. The non-halogen multilayer insulated wire according to claim 1, wherein the hydrolysis inhibitor comprises a carbodiimide skeleton.

5. The non-halogen multilayer insulated wire according to claim 1, wherein the inorganic porous filler comprises a fired clay.

6. A method of manufacturing a non-halogen multilayer insulated wire, the method comprising;
forming an inner layer covering the conductor, the inner layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate; and
forming an outer layer on the external surface of the inner layer, the outer layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.

7. A non-halogen multilayer insulation comprising:
an inner layer covering the conductor, the inner layer comprising a polyolefin resin composition including a high density polyethylene and a copolymer in a mass ratio on the range of 50:50 to 90:10, the copolymer including one of an ethylene-ethyl acrylate copolymer including 9% to 35% by mass of ethyl acrylate and an ethylene-vinyl acetate copolymer including 15% to 45% by mass of vinyl acetate; and
an outer layer on the external surface of the inner layer, the outer layer being made of a polyester resin composition that includes a base polymer mainly including a polyester resin and further includes, relative to 100 parts by mass of the base polymer, 50 to 150 parts by mass of a polyester block copolymer, 0.5 to 5 parts by mass of a hydrolysis inhibitor, 0.5 to 5 parts by mass of an inorganic porous filler, and 10 to 30 parts by mass of magnesium hydroxide.
